(19) United States
(12) Patent Application Publication
(10) Pub. No.: US 2018/0164664 A1
(43) Pub. Date: Jun. 14, 2018

(54) Grip Belt and Imaging Apparatus

(71) Applicant: JVC KENWOOD Corporation, Yokohama-shi (JP)

(72) Inventors: Toshiyuki YAKABE, Yokohama-shi (JP); Kazuhiro KURAMOTO, Yokohama-shi (JP); Masahiro YAMAMOTO, Yokohama-shi (JP); Akemi ICHIYANAGI, Yokohama-shi (JP); Yuzuko Sasaki, Yokohama-shi (JP); Takuya ARIMOTO, Yokohama-shi (JP); Akihiko MIYAMORI, Yokohama-shi (JP)

(21) Appl. No.: 15/834,641

(22) Filed: Dec. 7, 2017

(30) Foreign Application Priority Data
Dec. 14, 2016 (JP) 2016-242247

(51) Int. Cl. G03B 17/56; H04N 5/225

(52) U.S. Cl. CPC G03B 17/563; H04N 5/2251

(57) ABSTRACT

An imaging apparatus has a body portion and a grip belt. The body portion has an imaging element. The grip belt is connected to and supported on the body portion at a first connection portion on a front part of the body portion, a second connection portion on a lower rear part of the body portion, and a third connection portion on an upper rear part of the body portion, in a standard position in which a horizontal direction and a vertical direction in a pixel array of the imaging element are respectively made horizontal and vertical.

### CROSS REFERENCE TO RELATED APPLICATION

This application claims benefit of priority under 35 U.S.C. §119 to Japanese Patent Application No. 2016-242247, filed on Dec. 14, 2016, the entire contents of which are incorporated by reference herein.

### BACKGROUND

The present invention relates to a grip belt and an imaging apparatus, and more particularly, to a grip belt that allows a user to hold a body portion of an imaging apparatus with a feeling of good holding and the imaging apparatus having the same.

An imaging apparatus to be used by holding a body portion of the imaging apparatus with a hand of a user by inserting the hand between the body portion and a grip belt, has been known. The grip belt has both ends supported at a front end and a rear end of the body portion in a front-back direction that is a direction of an optical axis of the body portion. Such an imaging apparatus is generally called a handy-type, which includes a still camera and a video camera, for example. Patent Literature 1 (Japanese Patent Application Laid-Open No. 2006-251177) describes an example of the video camera.

A conventional handy-type imaging apparatus has a grip belt supported at two points that are a front end and a rear end of a body portion. With the body portion held with a hand of a user, the center of gravity of the body portion is adequately isolated from the hand and is positioned above the support position of the grip belt, in general. For this reason, an upper part of the body portion is likely to move around the front-back direction toward a direction leaving from the hand. It is thus hard for the user to get a feeling of good holding that the body portion closely fits into the hand, and improvements described in Patent Literature 1 have been made.

In this situation, the shape of the body portion has recently changed with further miniaturization of the imaging apparatus and technical improvements of batteries. Specifically, a conventional battery was flat and had an approximately rectangular parallelepiped shape, which was mounted and arranged on the body portion at a portion against which a hand of a user is to be put. Instead, a battery, which has a pillar shape (for example, a column shape) extending in a front-back direction, has been recently installed. In case of applying a battery in the pillar shape, a side-protrusion at the portion of the body portion against which the hand is to be put becomes remarkable. Consequently, the center of gravity is positioned further away from the hand. This makes it more difficult to get the feeling of good holding than in the conventional case. Thus, further devising to hold the body portion with the feeling of better holding is desired.

### SUMMARY

An object of the present invention is to provide a grip belt that allows a user to hold a body portion with a feeling of better holding and an imaging apparatus having the same.

According to a first aspect of an exemplary embodiment, there is provided a grip belt including a first end from which the grip belt extends in a first direction, and a second end branching into a first belt portion and a second belt portion.

According to a second aspect of the exemplary embodiment, there is provided an imaging apparatus, including a body portion having an imaging element, and a grip belt connected to and supported on the body portion at a first connection portion on a front part of the body portion, a second connection portion on a lower rear part of the body portion, and a third connection portion on an upper rear part of the body portion, in a standard position in which a horizontal direction and a vertical direction in a pixel array of the imaging element are respectively made horizontal and vertical.

### BRIEF DESCRIPTION OF THE DRAWINGS

FIG. 1 is a first perspective view of a video camera, which is an example of an imaging apparatus according to an exemplary embodiment of the present invention.

FIG. 2 is a second perspective view of the video camera.

FIG. 3 is a right side view of the video camera.

FIG. 4 is a rear view of the video camera.

FIG. 5 is a development plan illustrating a grip belt, which is an example of a grip belt according to an exemplary embodiment of the present invention.

FIG. 6 is a third perspective view of the video camera held with a right hand of a user.

FIG. 7 is a right side view of the video camera held with the right hand.

FIG. 8 is a rear view of the video camera held with the right hand.

FIG. 9 is a right side view of a grip belt, which is a first modified example of the grip belt.

FIG. 10 is a right side view of a grip belt, which is a second modified example of the grip belt.

### DETAILED DESCRIPTION

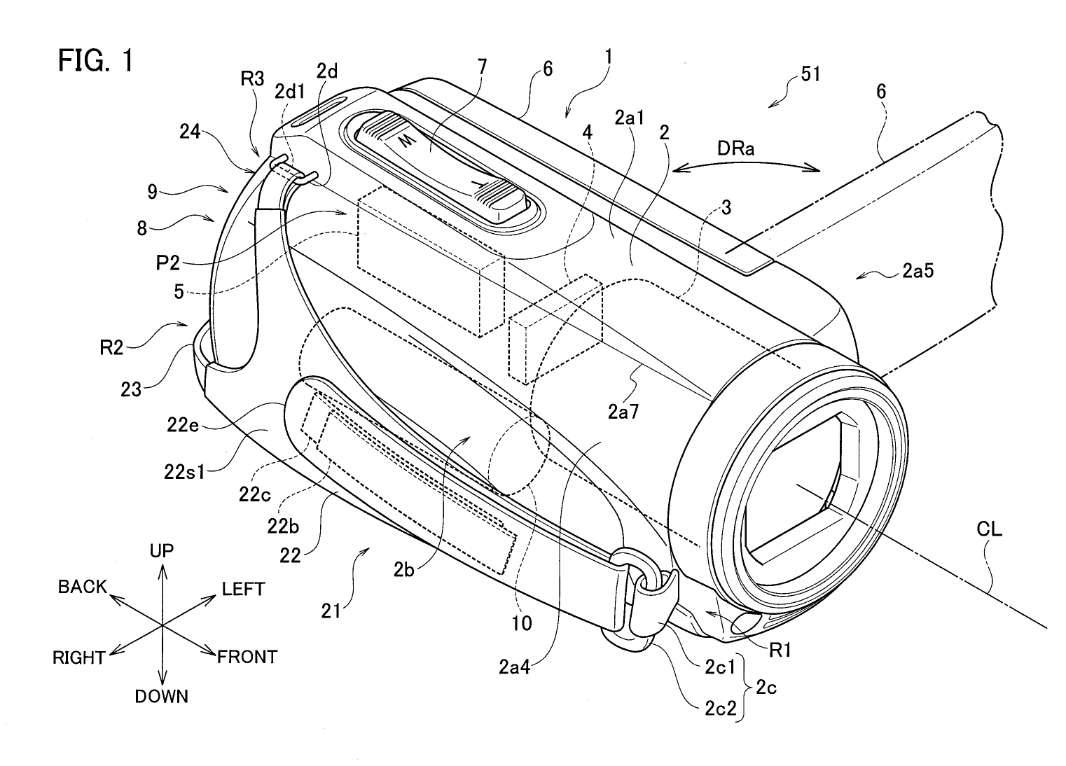

A grip belt and an imaging apparatus according to an exemplary embodiment of the present invention will be described by means of a grip belt 21 and a video camera 51, which are examples. First, a schematic configuration in appearance will be described with reference to FIGS. 1 to 4. In the following descriptions, a front-back direction is defined as an optical axis CL direction (subject side is front), and the top and bottom and the left and right of an image obtained by the video camera 51 are respectively defined as an up-down direction and a left-right direction by arrows shown in each drawing.

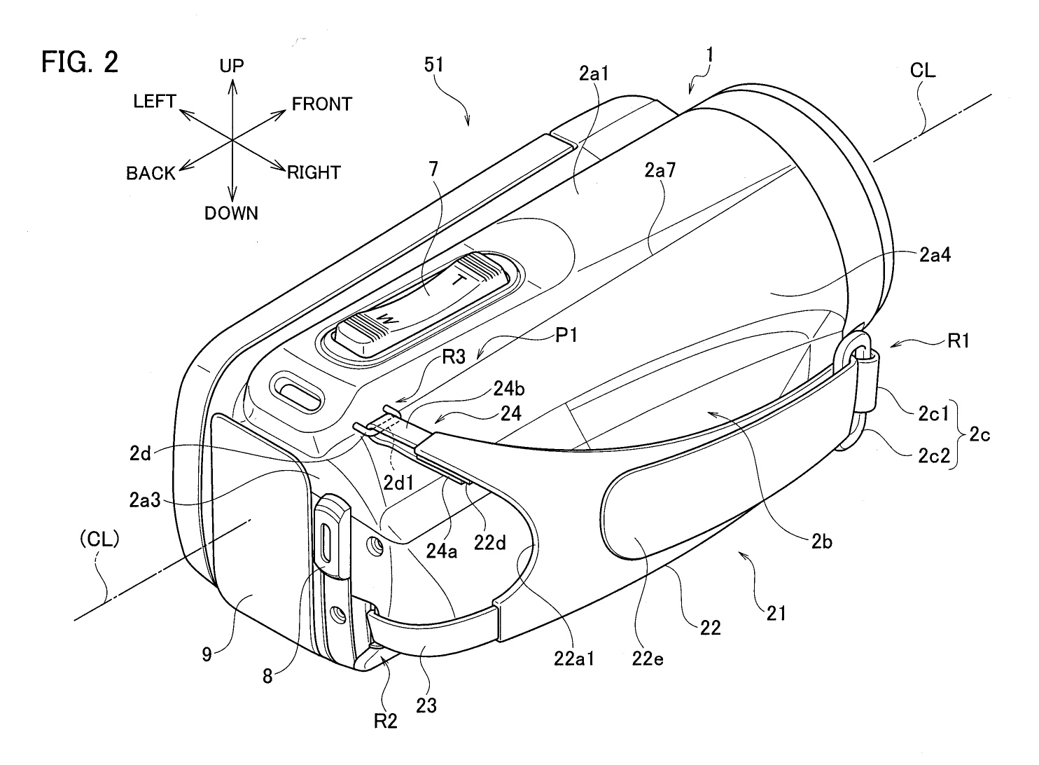

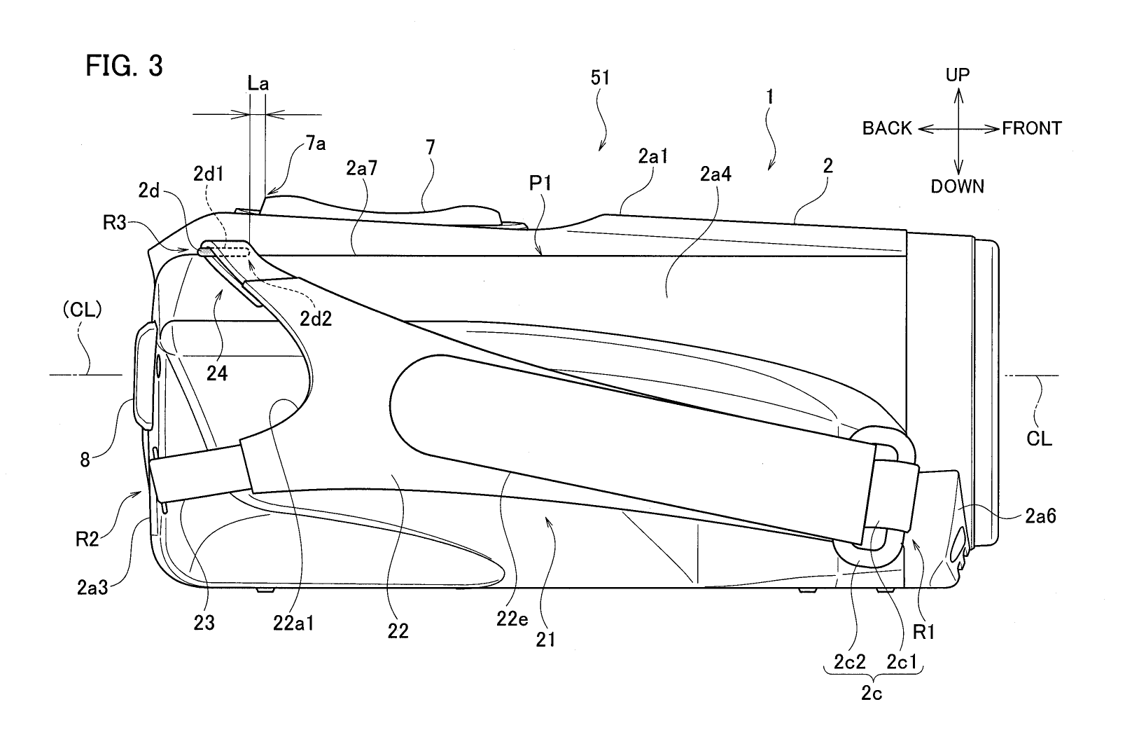

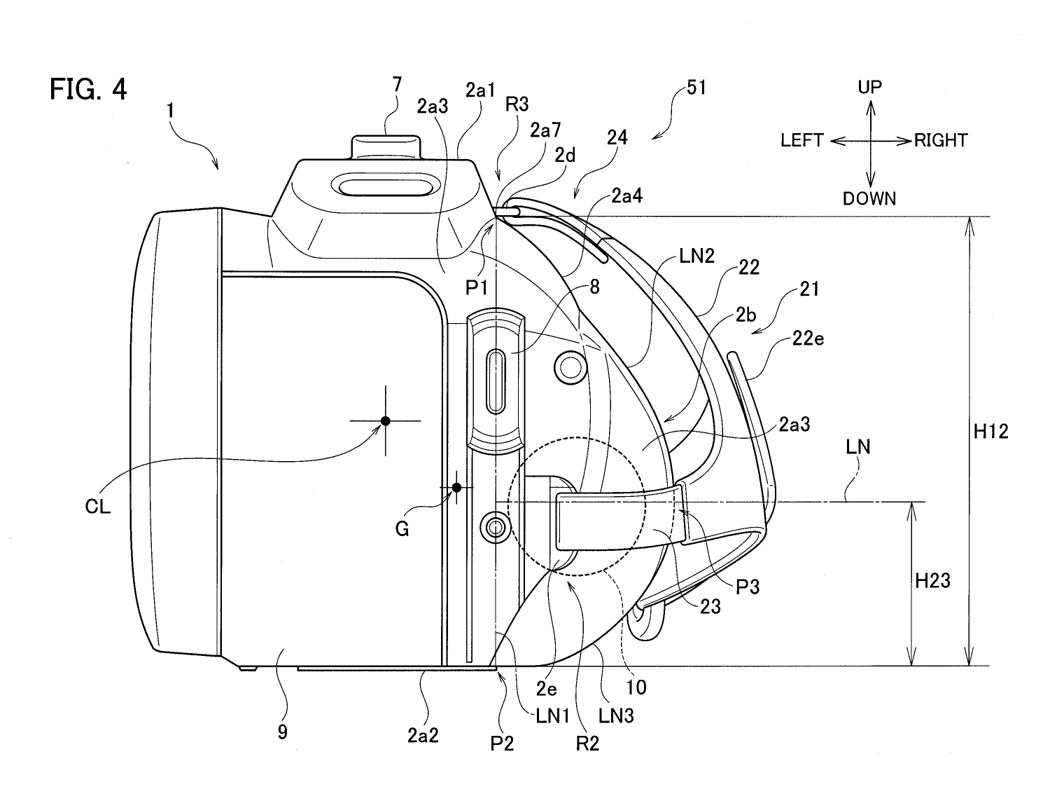

FIG. 1 is a perspective view of the video camera 51 viewed obliquely from the front upper right. FIG. 2 is a perspective view of the video camera 51 viewed obliquely from the rear upper right. FIGS. 3 and 4 are a right side view and a rear side view of the video camera 51, respectively.

The video camera 51 includes a body portion 1, which is longitudinally elongated, and a grip belt 21, which is mounted on a side of the body portion 1, the side including a right side surface 2a4. In FIG. 1, the body portion 1 includes a housing 2, a lens portion 3 arranged in a front part of the inside of the housing 2, an imaging element 4, which is arranged just behind the lens portion 3 and converts an optical image of a subject taken by the lens portion 3 into an electric signal, and a circuit portion 5, which processes the electric signal from the imaging element 4. Hereinafter, a position, in which a horizontal direction and a vertical direction in a pixel array of the imaging element 4 are made horizontal and vertical, respectively, is called a standard position.

In FIG. 1, a monitor portion 6 is mounted on a left side surface 2a5 of the housing 2. The monitor portion 6 is rotatable (arrow direction DRa) between a closed position (solid line) along the body portion 1, and an open position (two-dot chain line) at which the monitor portion 6 is open by rotating approximately 90 degrees with respect to the closed position. At a rear part of an upper surface 2a1 of the housing 2, a zoom switch 7 as an operation portion is disposed. The zoom switch 7 is a seesaw type, which is operated to swing back and forth with an index finger and a middle finger of a user when the video camera 51 is held in the ordinary way. In FIGS. 2 and 4, a recording button 8 is disposed at a slightly upper right part with respect to the center of a rear surface 2a3 of the housing 2. On the left of the recording button 8, a terminal cover 9 to cover input/output terminals is mounted to open and close.

As shown in FIGS. 1 to 4, a battery 10 is housed in a right part of the inside of the housing 2. The battery 10 has a pillar-shape (for example, a round column) and is housed in the housing 2 in a position where the battery 10 extends in the front-back direction.

As shown in FIG. 4, a portion in the left-right direction, in which the battery 10 is housed, is positioned such that it protrudes to the right with respect to a line LN1 virtually connecting a position P1 on a right edge of the upper surface 2a1 and a position P2 on a right edge of a lower surface 2a2 of the housing 2. On design, the body portion 1 is thus formed with a contact portion 2b for putting a palm of a hand of the user thereon, which protrudes to the right over the line LN1 virtually connecting the position P1 and the position P2. In the exemplary embodiment, the line LN1 is defined as extending approximately in the up-down direction.

An external shape of the contact portion 2b is an arc in a convex shape toward the right in a rear view shown in FIG. 4. As shown by a height line LN, a position P3, which is a maximum protruding position to the right in the contact portion 2b, is below a middle position of a height H12. The height H12 is between the position P1 and the position P2, and corresponds to the height of the housing 2 in the up-down position. That is, a height H23 from the position P2 to the position P3 is expressed by:

H23<H12/2 (expression 1)

An external line of the contact portion 2b passing through the position P3 in the rear view in FIG. 4 thus includes an arc-shaped curve LN2, which is gentle toward the position P1 in an upper part of the housing 2, and an arc-shaped curve LN3, which is steeper than the arc-shaped curve LN2 toward the position P2 in a lower part of the housing 2.

The contact portion 2b extends in the front-back direction, which is from a front part of the housing 2 to a rear part of the housing 2 in this example. The contact portion 2b is formed to satisfy (expression 1) at any position in the front-back direction in the range of the extension.

As shown in FIG. 4, a battery having a large mass is positioned such that it leans to the lower right inside the housing 2. Consequently, the center of gravity G when the monitor portion 6 is in the closed position, is also leaning to the right and slightly lower than the center in the left and right of the housing 2. When the monitor portion 6 is moved to the open position, the center of gravity G shifts to the left.

Next, the grip belt 21 will be described in detail. The grip belt 21 is connected to and supported on the housing 2 at three points, which are a connection portion R1, one point in the front part of the housing 2, and connection portions R2 and R3, two points in the rear part of the housing 2. Among these connection portions R1 to R3, the connection portion R2 is connected by a manufacturer, and the connection portions R1 and R3 are to be connected by a user who purchases the video camera 51.

The connection portion R1 is positioned on or near a front surface 2a 6, which is below an optical axis CL on the right side surface 2a4 of the housing 2. The connection portion R1 of the housing 2 is provided with a hook belt 2c to which the grip belt 21 is to be mounted by the user. As shown in FIG. 1, the hook belt 2c includes a connection belt 2c1 with one end fixed to the housing 2, and a ring 2c2 held by the connection belt 2c1.

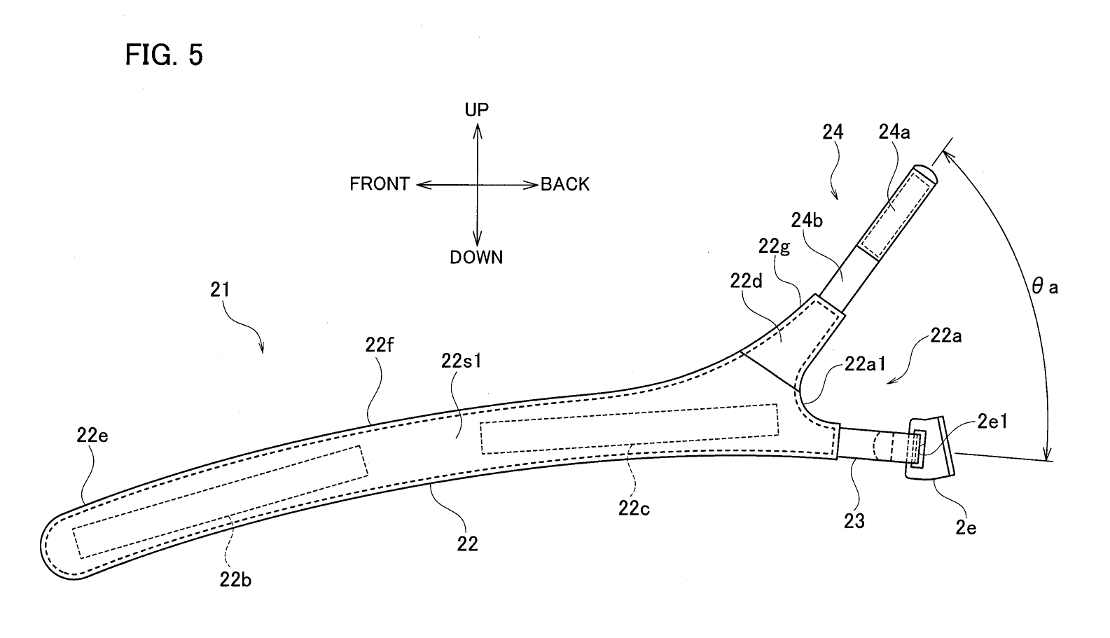

As obvious from FIG. 4, the connection portion R2 is positioned at the lower right with respect to the optical axis CL on the rear surface 2a3 of the housing 2. This position is also the lower right with respect to the recording button 8. To the connection portion R2 of the housing 2, a bracket 2e previously mounted on the grip belt 21 (see FIGS. 4 and 5) is mounted in the process of manufacturing the imaging apparatus 51. Consequently, the video camera 51, which is purchased by the user, has the grip belt 21 connected to the housing 2 only at the connection portion R2.

The connection portion R3 is positioned at a rear part of a ridgeline portion 2a7 connecting the upper surface 2a1 and the right side surface 2a4. The ridgeline portion 2a7 is a concave ridgeline, which is an internal corner, on the exterior shape of the video camera 51.

As shown in FIGS. 1 to 4, the connection portion R3 of the housing 2 is provided with a hook 2d to which the grip belt 21 is to be connected by the user. The hook 2d is formed nearly in a U-shape with a pair of arms extending in the same direction from both ends of a base portion 2d1 in a stick shape. The base portion 2d1 is a portion over which the grip belt 21 is to be hooked and by which the grip belt 21 is to be supported. The base portion 2d1 is provided to extend in the front-back direction.

The hook 2d is positioned behind the zoom switch 7. In detail, as shown in FIG. 3, a distance La in the front-back direction between a front end part 2d2 of the hook 2d and a rear end part 7a of the zoom switch 7 is defined as 0 (zero) or more.

FIG. 5 is a development of components for describing the grip belt 21 with the bracket 2e mounted thereon. The grip belt 21 is illustrated viewed from the contact portion 2b with the grip belt 21 mounted on the body portion 1. For easy understanding, the front-back direction and the up-down direction in the grip belt 21 approximately correspond to the front-back direction and the up-down direction of the video camera 51 respectively, in use. Accordingly, in FIG. 5, the back side of the paper is the right, and the front side of the paper is the left.

In FIG. 5, the grip belt 21 has a base portion 22, which is flat and elongated in the front-back direction, showing an arc in a slightly convex shape in an upward direction. The base portion 22 is made of a material well-known as one for the grip belt, and has flexibility in compression in a bent direction and a thick direction. An example of the material is a PET (polyethylene terephthalate) resin.

The base portion 22 includes a branch portion 22a at a rear part thereof, at which the base portion 22 vertically branches into two. In detail, at the branch portion 22a, one of the two of the base portion 22 is connected to a lower connection belt 23, and the other of the two includes a separation upper portion 22g and is connected to an upper connection belt portion 24. The lower connection belt 23 extends with keeping a curvature of the base portion 22. The separation upper portion 22g is a portion branching off and extending upward. The upper connection belt portion 24 extends from the separation upper portion 22g.

In detail, the upper connection belt portion 24 branches upward at a branch angle θₐ with respect to the lower connection belt 23, which goes along an extending direction of the base portion 22. The branch angle θₐ is, for example, 60 degrees and is desirable to be 45 degrees or more (details will be described later). That is, the upper connection belt portion 24 extends in a direction orthogonal or oblique with respect to the extending direction of the base portion 22. A rear edge part 22a1 of the branch portion 22a of the base portion 22, which connects an upper edge of the lower connection belt 23 and a lower edge of the upper connection belt portion 24, is formed in an arc in a smooth convex shape, which is at the inside of the branch portion 22a.

The upper connection belt portion 24 and the lower connection belt 23 have flexibility in folding, and are made of a PET resin, for example.

The lower connection belt 23 has a tip part passed through an aperture 2e 1 of the bracket 2e to be folded back and fixed. This enables the bracket 2e to be held at the tip part of the lower connection belt 23.

The grip belt 21 has a pair of a male and a female of a hook-and-loop fastener attached at two areas. A first area is on a right surface 22s1 of the base portion 22 (the back side of the paper of FIG. 5, see also FIG. 1). On the right surface 22s1, a first surface fastener 22b and a second surface fastener 22c are separately attached at a front part and a rear part, sandwiching an approximate middle part in the extending direction of the base portion 22. The first surface fastener 22b is one of the male and the female of the hook-and-loop fastener, and the second surface fastener 22c is the other of the male and the female of the hook-and-loop fastener.

As shown in FIG. 1, a front end part 22e of the base portion 22 is passed through the ring 2c2 of the hook belt 2c from the inside (housing 2 side) toward the outside, and folded back to engage the first surface fastener 22b on the second surface fastener 22c. This enables a front part of the grip belt 21 to be connected and supported at the connection portion R1.

By changing the length of the front end part 22e to be folded back, that is, by changing an engagement position of the first surface fastener 22b with respect to the second surface fastener 22c in the front-back direction, it is possible to adjust a distance of an extending surface in the grip belt 21 in the front-back direction to be short or long.

A second area is on the upper connection belt portion 24. A third surface fastener 24a, which is one of a male and a female of a hook-and-loop fastener, is attached on a left surface (the front side of the paper of FIG. 5) of a tip part of the upper connection belt portion 24. Moreover, a fourth surface fastener 22d, which is the other of the male and the female of the hook-and-loop fastener with which the third surface fastener 24a is to be engaged, is attached on a vicinity of the upper connection belt portion 24 on the base portion 22. Accordingly, a folded back portion 24b between the third surface fastener 24a and the fourth surface fastener 22d is a portion where a foundation of the upper connection belt portion 24 is exposed.

As shown in FIG. 2, the tip part of the upper connection belt portion 24 is passed through the hook 2d such that it hangs on the base portion 2d1 downward and is folded back. The third surface fastener 24a is thus engaged with the fourth surface fastener 22d provided on the base portion 22. This enables the upper connection belt portion 24 to be connected and supported at the connection portion R3.

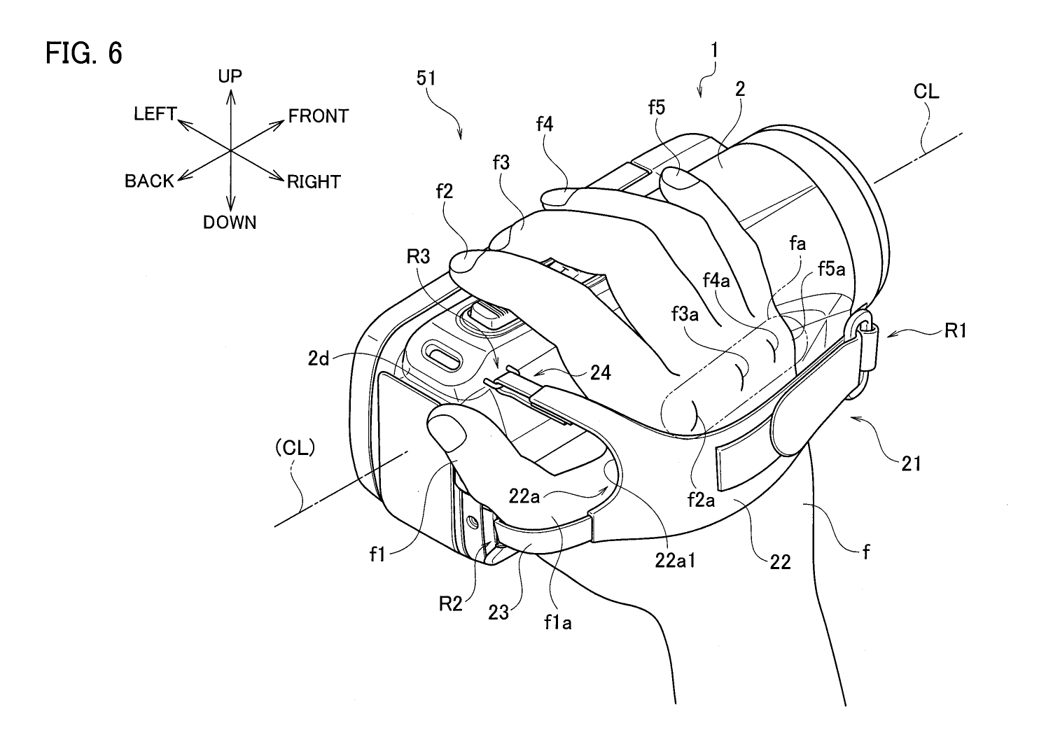

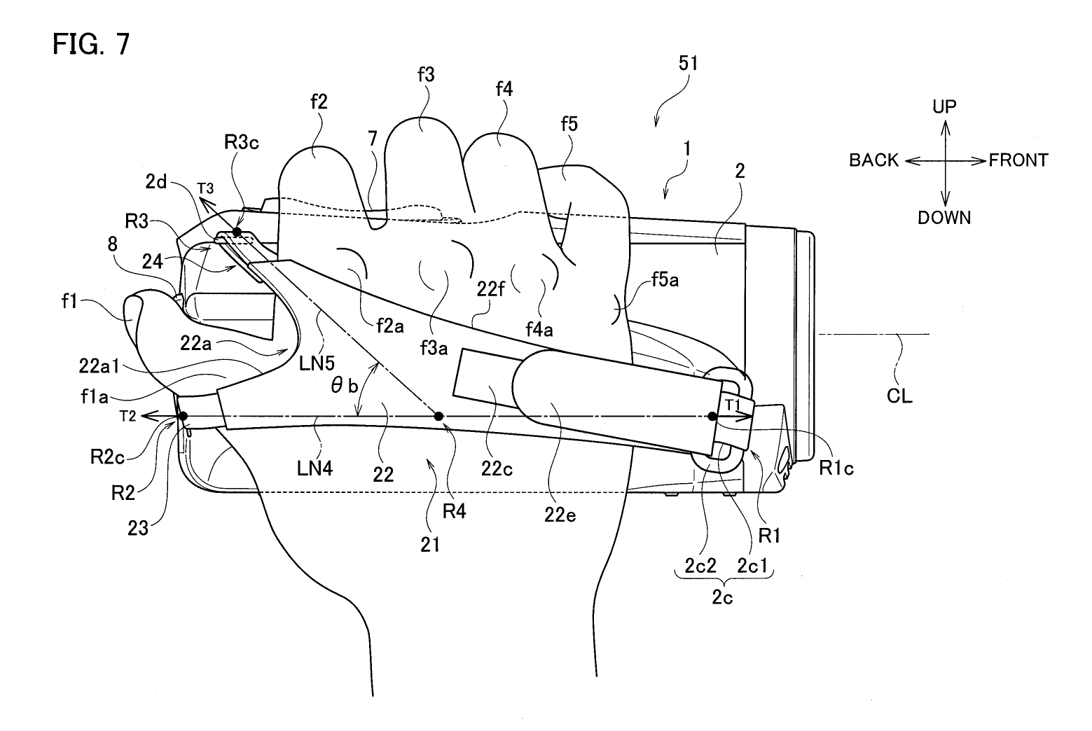

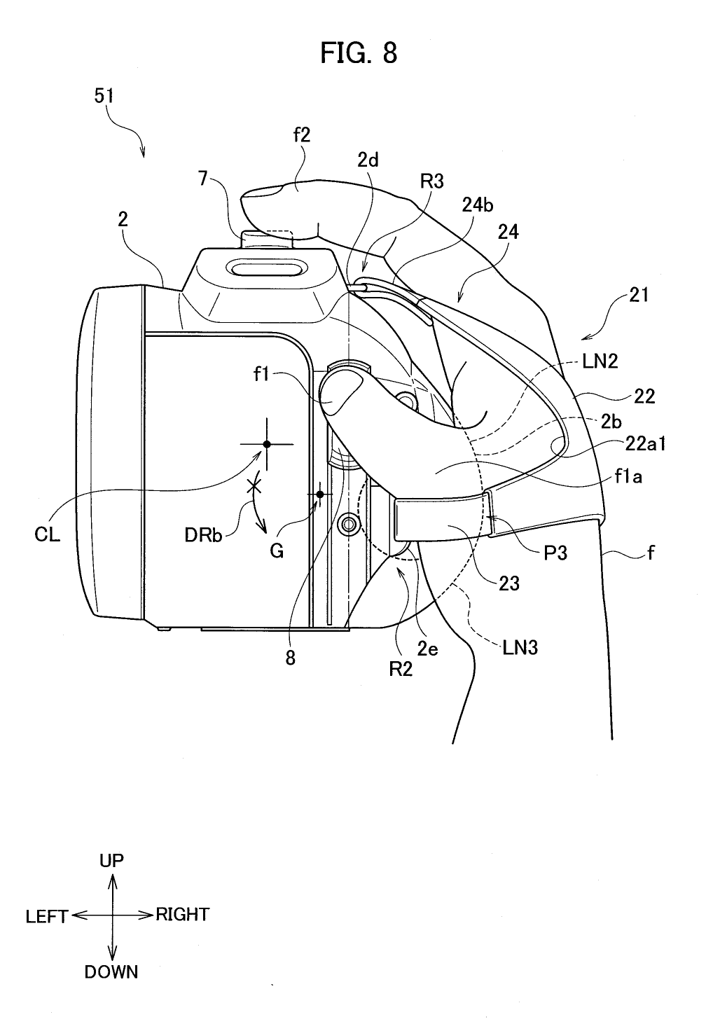

As described above, the imaging apparatus 51 including the body portion 1 and the grip belt 21 mounted on the body portion 1 is held with a right hand f of the user in a holding state shown in FIGS. 6 to 8. FIGS. 6 to 8 show a state in which the body portion 1 is in the standard position. FIG. 6 is a perspective view of the imaging apparatus 51 viewed obliquely from the rear upper right and corresponds to FIG. 2. FIG. 7 is a right side view of the imaging apparatus 51 and corresponds to FIG. 3. FIG. 8 is a rear side view of the imaging apparatus 51 and corresponds to FIG. 4.

As shown in FIGS. 6 to 8, when the user holds the body portion 1, the user inserts the right hand f between the contact portion 2b of the housing 2 (FIG. 8) and the base portion 22 of the grip belt 21 from the lower part toward the upper part of the housing 2. Then, the palm of the hand closely fits to the contact portion 2b with a feeling of suitable oppression, and the user tightens the grip belt 21 to stably hold the body portion 1. Specifically, a distance of an extending surface between the connection portion R1 and the connection portion R2 on the base portion 22 is suitably shortened by adjusting (increasing) the amount of folding back at the ring 2c2 at the connection portion R1.

Moreover, when an upper part of the body portion 1 is likely to move around the front-back direction toward a direction leaving from the right hand f holding the body portion 1, it is possible to suitably shorten a distance between the connection portion R3 and the right hand f by adjusting the length of the upper connection belt portion 24 to be folded back. This prevents the body portion 1 from moving and enables the body portion 1 to closely fit to the right hand f. To pull out the right hand f downward at the end of holding, it is only needed to reduce the amount of folding back at the connection portion R1 to loosen the grip belt 21. It is not needed to adjust the folding back of the upper connection belt portion 24.

As shown in FIGS. 6 and 7, in holding of the body portion 1, a thumb f1 naturally sits over the recording button 8 by passing through the thumb f1 between the lower connection belt 23 and the upper connection belt portion 24. This enables the user to easily perform start/stop operations of recording. As an index finger f2 and a middle finger f3 are naturally put on a front end and a rear end of the zoom switch 7, the user can easily perform operations in a wide direction (zoom out) and in a telescope direction (zoom in). A third finger f4 and a little finger f5 are put on the upper surface 2a1 of the housing 2, and support the holding of the body portion 1 to stable the position of the imaging apparatus 51.

Under this holding state, the grip belt 21 is connected to the housing 2 at three points, the connection portion R1 at a front lower part of the housing 2, the connection portion R2 at a rear lower part of the housing 2, and the connection portion R3 at a rear upper part of the housing 2. The distance of the extending surface between the connection portion R1 and the connection portion R2 of the grip belt 21 is adjusted by the amount of folding back of the front end part 22e of the base portion 22. This enables the right hand f holding the body portion 1 to be put against the contact portion 2b with an appropriate pressing force.

A distance of an extending surface between the base portion 22 of the upper connection belt portion 24 and the connection portion R3 is adjusted by an increase or a decrease of the amount of folding back at the hook 2d. This prevents the housing 2 from moving in a counterclockwise direction (arrow DRb) around the center of gravity G shown in FIG. 8 (mark “x” is given as prevention of moving). That is, the upper connection belt portion 24 prevents the upper part of the body portion 1 from moving to leave from the right hand f. This improves the degree of close fitting between the housing 2 and the right hand f, and provides the user with a feeling of good holding.

As described above, the upper connection belt portion 24 is provided to branch from the base portion 22 upward with respect to the extending direction of the base portion 22. For this reason, the adjustment of the distance of the extending surface between the base portion 22 and the connection portion R3 on the upper connection belt portion 24 does not have a great impact on the force pressing the back of the hand, which corresponds to tension obtained by adjusting the distance of the extending surface in the base portion 22. That is, it is substantially possible to separately adjust a feeling of pressing against the contact portion 2b for the right hand f, and a feeling of following and a feeling of close fitting to the right hand f by making the body portion 1 non-movable. This enables the user to obtain a feeling of better holding.

As shown in FIG. 3, the hook 2d is disposed behind the zoom switch 7. In detail, a distance between the front end part 2d2 of the hook 2d and the rear end part 7a of the zoom switch 7 in the front-back direction is defined as a distance La. The position of the front end part 2d2 and the position of the rear end part 7a in the front-back direction are made coincide (La=0), or a space is provided between the front end part 2d2 and the rear end part 7a (La>0). This prevents the index finger, which lowers a rear part of the zoom switch 7 (zoom down), from easily interfering with the upper connection belt portion 24. The user thus obtains a feeling of good holding and a feeling of good operation in zoom operations.

As shown in FIGS. 6 to 8, the rear edge part 22a1 of the branch portion 22a of the grip belt 21 comes into contact with a root portion f1a of the thumb f1 of the right hand f holding the housing 2. The root portion f1a is a portion on the back of the hand, which corresponds to a thenar on the palm of the hand, and a part having a thickness of the hand gradually increasing from a side of the thumb f1.

As described above, the rear edge part 22a1 of the grip belt 21 is formed in an arc hollowed toward the front end part 22e of the base portion 22. The rear edge part 22a1 thus extends not in an orthogonal direction, instead but along a direction in which the thickness of the right hand f increases at the root portion f1a to come into contact with the right hand f. This prevents the rear edge part 22a1 from contacting the right hand f like biting into the right hand f, and makes the feeling of holding good.

The shape of the base portion 22 of the grip belt 21 is set as follows by virtually defining a line LN4 on the imaging apparatus 51 (see FIG. 7).

That is, the line LN4 in FIG. 7 is defined as a line connecting a middle position R1c of the connection portion R1 of the grip belt 21 in the up-down direction, and a middle position R2c of the connection portion R2 of the grip belt 21 in the up-down direction. FIG. 7 is the right side view of the imaging apparatus 51 held with the right hand f, in which the optical axis CL and the left-right direction are made horizontal. In this situation, the shape of the base portion 22 is preferably formed to include the line LN4. In FIG. 7, directions in which the line LN4 extends correspond to directions of tension T1 at the connection portion R1 and tension T2 at the connection portion R2, which are in opposite directions each other.

By forming the base portion 22 to include the line LN4, the grip belt 21 hardly has a deformation at the base portion 22, such as a bend and wrinkles. Moreover, the base portion 22 comes into surface-to-surface contact with the back of the right hand f. The user thus obtains a feeling of good holding of the body portion 1. Furthermore, the span of life of the grip belt 21 extends, and the grip belt 21 can be used for a longer term, as the base portion 22 is not hardly deformed.

In the right side view in FIG. 7, a line LN5 is defined virtually, which extends from a middle position R3c of the connection portion R3 in the front-back direction along an extending direction of the upper connection belt portion 24 toward an intersection point R4 with the base portion 22. An angle θ_{b} (0≤θ_{b}≤90 degrees) between the line LN4 and the line LN5 is substantially the same as the branch angle θₐ on the grip belt 21 itself (see FIG. 5).

Here, an influence of tension T3 on the tension T1 and the tension T2 is considered, which is applied at the connection portion R3 on the grip belt 21. The tension T3 is a force in the direction along the line LN5. As the angle θ_{b} is made larger (closer to 90 degrees), a branch force of the tension T3 along the line LN4 becomes smaller, and the influence on the tension T1 and the tension T2 also becomes smaller. At the same time, the influence of the tension T1 and the tension T2 on the tension T3 also becomes smaller. That is, as the angle θ_{b}, that is the branch angle θₐ, is made closer to 90 degrees, the degree of tension at the upper connection belt portion 24 is not hardly changed by the degree of tension at the base portion 22, which is preferable.

For the angle θ_{b}, it is necessary to provide the branch portion 22a with a considerable amount of hollow for inserting the thumb f1. Moreover, it is necessary to prevent the upper connection belt portion 24 from interfering with the index finger f2 operating the zoom switch 7. For these reasons, the angle θ_{b} cannot be brought closer to 90 degrees excessively, and a preferable range is naturally defined. As a result of consideration, when the angle θ_{b} is defined approximately in the range of 45 degrees to 70 degrees, the shape of the branch is formed without unreasonableness and an effect of the tension is obtained, which is preferable.

As shown in FIG. 7, an upper edge part 22f of the base portion 22 of the grip belt 21 is positioned below a group of middle finger joints f2a, f3a, f4a, and f5a of four fingers excluding the thumb f1 of the right hand f holding the body portion 1 (hereinafter called a group of middle finger joints fa all together). That is, the base portion 22 does not hang on the group of middle finger joints fa of the right hand f holding the body portion 1.

The group of middle finger joints fa is a group of parts partially protruding because the four fingers excluding the thumb f1 are bent to put on the upper surface 2a1 (including the zoom switch 7) of the housing 2 to hold the body portion 1 with the right hand f. The base portion 22 of the grip belt 21 thus has a shape avoiding the group of middle finger joints fa not to cover the group of middle finger joints fa. This releases the group of middle finger joints fa and does not give a feeling of oppression on the right hand f. The user thus obtains the feeling of good holding in holding the body portion 1.

As shown in FIG. 8, the base portion 22 of the grip belt 21 corresponds to the position P3 (height line LN in FIG. 4) with the body portion 1 held with the right hand f. The position P3 is the maximum protruding position for the contact portion 2b, and the base portion 22 is formed to cover the position P3 such that the right hand f is sandwiched between the base portion 22 and the contact portion 2b. In FIG. 8, a shape shown by the arc-shaped line LN2 and the arc-shaped line LN3 extending upward and downward from the position P3 of the contact portion 2b allows the contact portion 2b to come into contact with the right hand f and to be pressed such that the contact portion 2b is surrounded by the palm of the right hand f. This makes the feeling of holding for the right hand f, which holds the body portion 1, better and the holding of the body portion 1 more stable.

The above-described embodiment is not limited to the above-noted configuration and may be made as modified example varied within a scope not deviating from the gist of the present invention.

### FIRST MODIFIED EXAMPLE

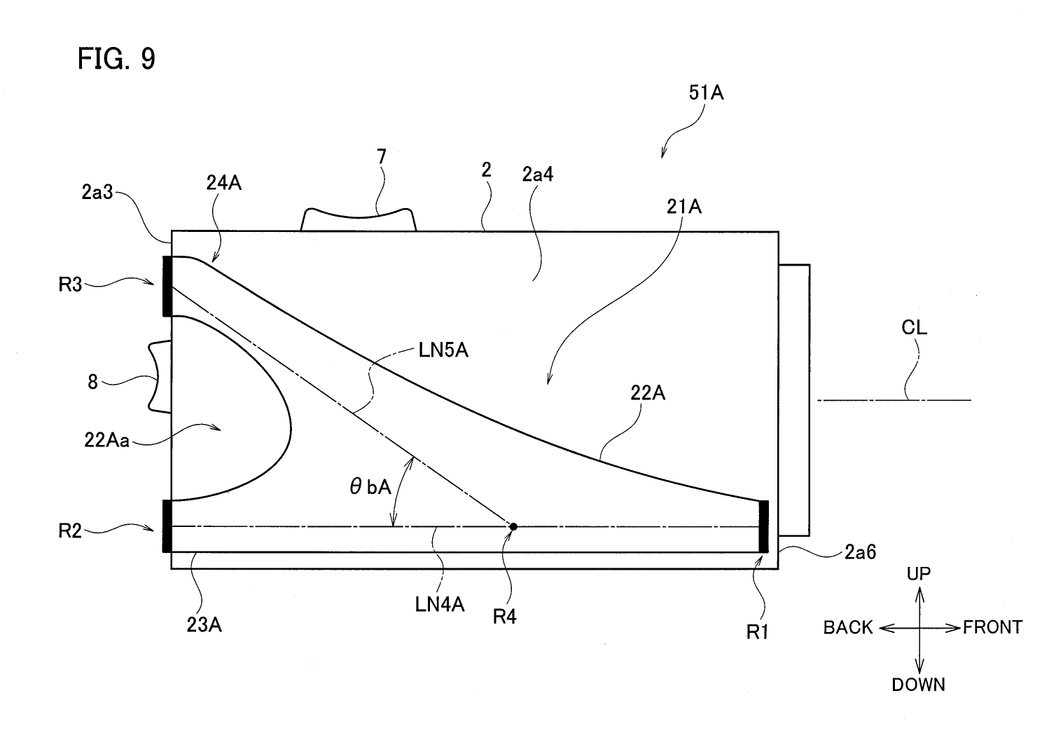

For example, the grip belt 21 may be a grip belt 21A in a first modified example shown in FIG. 9. For the grip belt 21A, the position of the connection portion R3 is not on the rear part of the ridgeline portion 2a7 connecting the upper surface 2a1 and the right side surface 2a4 on the housing 2, instead but set on an upper part of a ridgeline portion connecting the rear surface 2a3 and the right side surface 2a4. This example also obtains the improvement in the feeling of holding by the three-point support, as in the grip belt 21.

For the grip belt 21A, tan angle θ_{bA} between a line LN4A and a line LN5A corresponding to the line LN4 and the line LN5 of the grip belt 21 in the exemplary embodiment (see FIG. 7) is necessarily smaller than the angle θ_{b}. In this view, the grip belt 21 in the exemplary embodiment is preferable.

### SECOND MODIFIED EXAMPLE

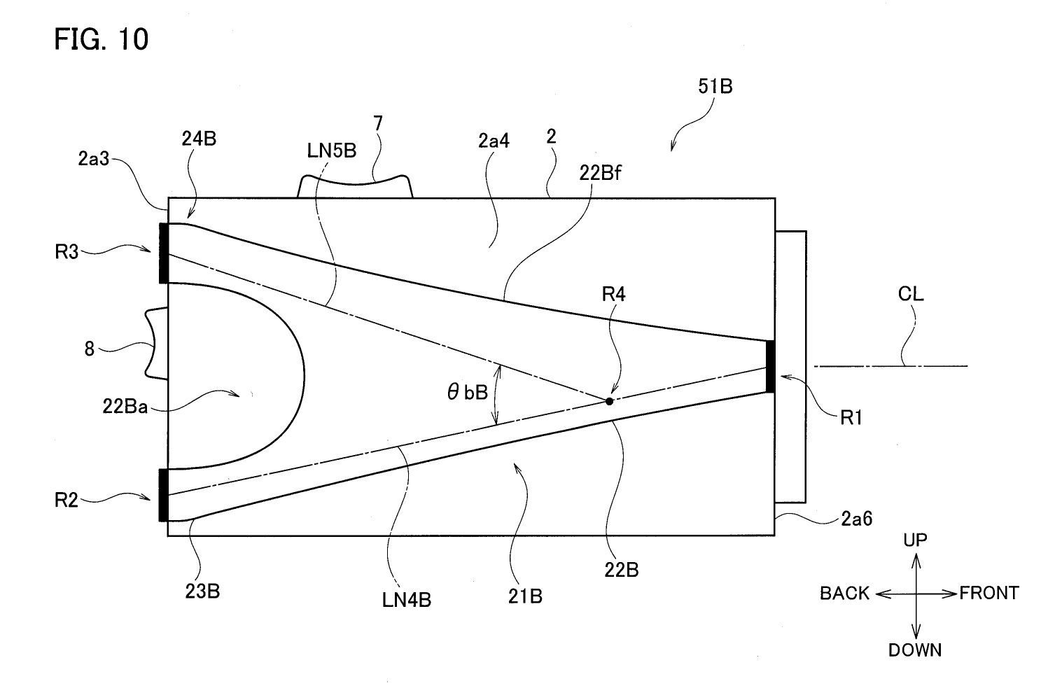

For example, the grip belt 21 may be a grip belt 21B in a second modified example shown in FIG. 10. For the grip belt 21B, the connection portion R2 and the connection portion R3 are at the same positions as in the grip belt 21A. The position of the connection portion R1 is set not on the lower part of the housing 2, instead but on a middle part (for example, at a position of the optical axis CL) of the housing 2. As same as the grip belts 21 and 21A, this example also obtains the improvement in the feeling of holding by the three-point support.

For the grip belt 21B, a line LN4B corresponding to the line LN4 of the grip belt 21 in the exemplary embodiment inclines upward. Thus, it is not as easy as in the grip belts 21 and 21A to adjust the length of the grip belt 21B for the right hand f. Moreover, with a rise of the position of the connection portion R1, a position of an upper edge part 22Bf of the base portion 22B necessarily shifts upward, thereby having a possibility that the base portion 22B covers the group of middle finger joints fa. In this view, the grip belts 21 and 21A are preferable.

The imaging apparatus 51 is not limited to a video camera to take a moving image and a still camera to take a still image. It is only required that the imaging apparatus 51 is an apparatus to be held with a hand of a user to take an image. The zoom switch 7 and the recording button 8 may not be disposed on the above-described respective positions. The method of mounting the grip belt 21 on the housing 2 at the connection portions R1 to R3, and the determination as to whether or not a user can mount at the connection portions R1 to R3 are not limited to the above-described case. The adjustment of the distance of the extending surface in the grip belt 21 is not limited to the engagement by the surface fastener in the above-described embodiment. It may be by a buckle that is adjustable for length. Moreover, the grip belt 21 itself may be formed of a stretchable rubber material, thereby fitting on the hand by its stretch without depending on the adjustment of the length by the surface fastener or the buckle.

In the exemplary embodiment and respective examples, the imaging apparatus 51 provided with one of the grip belts 21, 21A, and 21B on the right side surface to hold the body portion 1 with the right hand f is described. As a symmetrical shape, a grip belt to hold the body portion 1 with a left hand and an imaging apparatus provided with the grip belt may be described.

As described above, according to the present exemplary embodiment, it is possible to hold the body portion with a feeling of better holding.

What is claimed is:

1. A grip belt comprising:
a first end from which the grip belt extends in a first direction; and
a second end branching into a first belt portion and a second belt portion.

2. The grip belt according to claim 1, wherein
the grip belt is to be mounted on a body portion of an imaging apparatus,
the first end is to be mounted on a front part of the body portion,
the first belt portion is to be mounted on a lower rear part of the body portion, and
the second belt portion is to be mounted on an upper rear part of the body portion.

3. The grip belt according to claim 1, wherein
a part of the grip belt between the first end and the first belt portion extends in the first direction, and
the second belt portion branches off and extends in a direction orthogonal or oblique to the first direction.

4. An imaging apparatus, comprising:
a body portion having an imaging element; and
a grip belt connected to and supported on the body portion at a first connection portion on a front part of the body portion, a second connection portion on a lower rear part of the body portion, and a third connection portion on an upper rear part of the body portion, in a standard position in which a horizontal direction and a vertical direction in a pixel array of the imaging element are respectively made horizontal and vertical.

5. The imaging apparatus according to claim 4, wherein
the grip belt includes a first end from which the grip belt extends in a first direction, and a second end branching into a first belt portion and a second belt portion, and
the first end is supported at the first connection portion, the first belt portion is connected and supported at the second connection portion, and the second belt portion is connected and supported at the third connection portion.

6. The imaging apparatus according to claim 4, wherein
in a side view of the body portion in the standard position, a first virtual line connecting the first connection portion and the second connection portion extends in a front-back direction below an optical axis, and the third connection portion is positioned on a second virtual line orthogonal or oblique to the first virtual line.

7. The imaging apparatus according to claim 4, wherein
the third connection portion is positioned on a rear part of a part connecting a side surface and an upper surface of the body portion.

8. The imaging apparatus according to claim 7, wherein
the upper surface has an operation portion thereon, and
the third connection portion is positioned behind the operation portion.

9. The imaging apparatus according to claim 4, wherein
with a hand inserted between the body portion and the grip belt to hold the body portion, middle finger joints of an index finger to a little finger of the hand are exposed to outside.
